(19) United States
(12) Patent Application Publication
(10) Pub. No.: US 2008/0121838 A1
(43) Pub. Date: May 29, 2008

(54) Optical brightener additive to cements and primers

(76) Inventors: Mark W. Brown, Downey, CA (US); Chirag R. Amin, Anaheim, CA (US)

Correspondence Address: David W. Collins;Intellectual Property Law, Suite 100, 512 E. Whitehouse Canyon Road, Green Valley, AZ, 85614, US

(21) Appl. No.: 11/595,202

(22) Filed: Nov. 10, 2006

(51) Int. Cl. G01N 21/64; C09K 13/00

(52) U.S. Cl. 252/79.1; 250/461.1

(57) ABSTRACT

An adhesive or primer is provided with an effective amount of an optical brightener material to enable detection by a source of UV radiation.

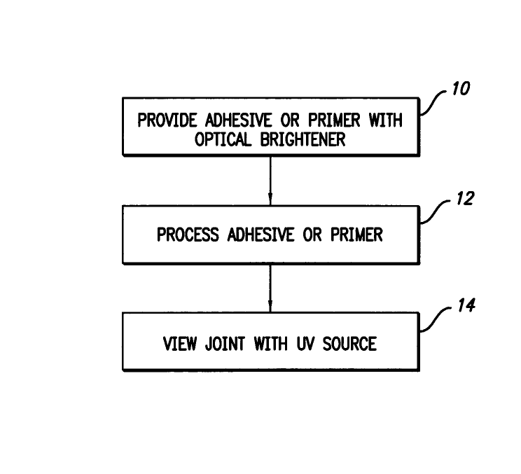

### TECHNICAL FIELD

The present invention is related to adhesives, also commonly known as cements, and primers, commonly used to join PVC, CPVC, and ABS pipes and fittings together, and, more particularly, to additives to distinguish one manufacturer from another or to detect spillage.

### BACKGROUND ART

The use of adhesives, or cements, and primers in the joining of polyvinyl chloride (PVC), chlorinated polyvinyl chloride (CPVC), and acrylonitrile-butadiene-styrene (ABS) pipes and fittings and other objects is well-known. Typically, such adhesives, or cements, comprise one or more of the respective resin components and one or more solvents. Primers simply comprise the mixture of solvents without the resin(s). Primers may be employed as part of a two-step process, comprising applying the primer to one or both surfaces of the pipes and fittings (or other objects) being joined, followed by applying the adhesive.

Solvent-based adhesives, or cements, have been in use for joining thermoplastic pipe for over 40 years. The development of these adhesives is largely responsible for growth of the thermoplastic pipe industry. Several billion pounds of plastic pipe are produced each year in North America. Rapid-setting, solvent-based adhesives weld the pipes together in a timely manner. These rapid-setting adhesives allow for the testing and trouble-shooting of piping systems in a matter of hours while maintaining the long-term durability of the pipe itself. These characteristics, rapid set, ease of use, long-term durability along with low-cost, have made the joining of plastic pipe and fittings by solvent-based adhesives a practical and economic system.

The solvent-based adhesives work primarily by two means of action. First, the solvent portion of the formulation softens the outer surfaces of the pipe (and inner surfaces of the fitting) through solvation of the plastic. Subsequently, the adhesive joint ‘cures’ (hardens) by means of the solvents evaporating to the surrounding atmosphere from the pipe. Secondly, the resin dissolved in the adhesive dries through solvent evaporation and provides continuity between the welded pipe and fitting surfaces which aid in preserving the integrity of the entire pipe system.

These adhesives cure rapidly (within a matter of hours), often allowing piping systems to be tested the same day as constructed. However, perhaps the most important benefit of these solvent-based adhesives is the maintenance of the integrity of the pipe itself. The resin is the same as the plastic pipe and/or fitting material. This provides a high degree of long-term durability for the piping system, often up to 30 to 40 years of useful life. This is essential for these systems, which are built into the structures of homes and buildings, or are buried underground.

Thousands of miles of thermoplastic piping systems are constructed each day throughout the world, primarily by the means previously described. These systems are used in the transfer of potable water for drinking; residential hot and cold water systems; drain, waste, and vent (DWV) applications in home and industry; turf and agricultural sprinkler systems; Jacuzzi, spa and tub connections, residential and commercial fire sprinkler systems; etc. These systems are crucial to the maintenance of safe and healthy means of transport of water and other chemicals throughout the world.

Evaporation of solvents from adhesives is a concern to an environmentally-concerned world, along with all other potential sources of air pollution. Typical solids (non-volatile) contents of plastic pipe adhesives are: 10 to 25% for PVC and CPVC and 15 to 40% for ABS. The balance of the formulation is solvent. By definition, the solvents normally used, e.g., tetrahydrofuran (THF), methyl ethyl ketone (MEK), cyclohexanone, acetone, and dimethylformamide (DMF) are considered to be VOCs. That is, they are volatile compounds that contain the element carbon excluding methane, carbon monoxide, carbon dioxide, carbonic acid, metallic carbides and carbonates, ammonium carbonate, and exempt compounds, such as methylene chloride and 1,1,1-trichlorethane. Typical VOC values of PVC and CPVC solvent adhesives range from 775 to 850 grams/liter (g/l), while ABS adhesives ranges from 650 to 750 g/l.

Regulations are being created throughout North America regarding allowable VOC levels in adhesive formulations. Federal, state, and local agencies are beginning to adopt strict measures to drastically reduce these levels. The South Coast Air Quality Management District (SCAQMD) in the Los Angeles area has been a leader of the establishment of rules governing VOCs, such as SCAQMD Rule 1168.

SCAQMD Rule 1168 specifies a maximum VOC level for PVC adhesives of 510 g/l, CPVC adhesives of 490 g/l, and ABS adhesives of 325 g/l, as determined by Method 316-A. Primers used in conjunction with PVC and CPVC adhesives are specified at a maximum VOC level of 550 g/l. All adhesives and primers used to join PVC, CPVC and ABS plastic pipes in SCAQMD are required to meet these maximum allowed levels. This rule has been in effect since April 1989, with the most recent amendment to the rule on Jan. 7, 2005.

With regard to adhesives, or cements, adhesives in the field may look the same. Although cements are often different colors, it is difficult to distinguish one manufacturer's blue cement from another blue cement, for example. It may be important to be able to identify the manufacturer in the event of leaks or spillage, for example.

With regard to primers, present codes typically specify a purple color, which makes it easy to inspect. However, if the primer is inadvertently dripped on a porous or reactive (e.g., vinyl) floor, it is not removable and creates an unsightly mess. The primer without the colorant is clear, and thus not easily detected if spilled.

Fluorescent and phosphorescent materials have been added to adhesives and primers. However, the amount required to be added to enable detection is so great as to adversely affect the properties required to act as an adhesive or primer.

### SUMMARY

In accordance with an aspect of the present invention, an adhesive or primer is provided with an effective amount of an optical brightener material to enable detection by a source of UV radiation.

As used herein, the term “effective amount” means that amount necessarily present to enable detection, without adversely affecting the properties required to act as an adhesive or primer.

### BRIEF DESCRIPTION OF THE DRAWING

The sole FIGURE depicts a flow chart for a method of detecting cements and primers on pipes, in accordance with an embodiment.

### DETAILED DESCRIPTION

In accordance with an aspect of the present invention, an adhesive or primer is provided with an effective amount of an optical brightener material to enable detection by a source of UV radiation.

In accordance with a further aspect of the present invention, a method of detecting at least one of the identity of a manufacturer or a leak or a spill of an adhesive or primer is provided. The method comprises:
providing an adhesive or primer for PVC, CPVC, or ABS pipe joints that contains an effective amount of an optical brightener material;
processing the adhesive or primer; and
detecting the adhesive or primer with a source of UV light.

With regard to adhesives, the presence of an optical brightener additive enables identification of the manufacturer.

With regard to primers, the presence of an optical brightener additive enables the primer to be clear, so that any reaction with the floor, for example, is only visible in the presence of UV radiation such as emitted by a “black light”.

In both cases, the optical brightener may be employed in relatively low concentration, by which is meant that a relatively small amount is required to be detected in the presence of the black light, but such small amount has virtually no effect on the adhesive or primer properties, as the case may be. In this connection, in an embodiment, the concentration of the optical brightener is within the range of 0.001 to 0.9 weight percent (wt %) of the total formulation of the adhesive or primer, and in some embodiments, is in the range of 0.005 to 0.5 wt %, most preferably about 0.01 wt %.

The optical brighteners may be employed for joining with all PVC (polyvinyl chloride), CPVC (chlorinated polyvinyl chloride), and ABS (acrylynitrile-butadiene-styrene) items, such as pipes and fittings, as well as primers and cleaners for the same. Further, the optical brighteners may be used in “transition cements”, such as used to join ABS and PVC together, for example.

An optical brightener may be defined as a chemical that absorbs light and then emits light in a visible region. Examples of optical brighteners that may be suitably employed in the practice of the invention include, without limitation, oxazole derivatives and biphenyl derivatives. Specific examples of oxazole derivatives include, without limitation, 2,2′-(1,2-ethenediyl-di-4,1-phenylene) bisbenzoazole, available from Lenape Industries, Inc. (Hillsborough, N.J.) as LENBRITE OB-1 (CAS # 1533-45-5), 2,2′-(2,5-thiophenydiyl)-bis[5-(1,1′-dimethyl) benzoxazole, available from Lenape Industries, Inc. (Hillsborough, N.J.) as LENBRITE OB(D) (CAS # 7128-64-5), 2,5-bis-(benzoxazole-2-) thiophene, available from Lenape Industries, Inc. (Hillsborough, N.J.) as LENBRITE PB (CAS # 2866-43-5), and 2,2-(1,4-naphthalenediyl)bis-benzoxazole. Specific examples of biphenyl derivatives include, without limitation, 1,1′-biphenyl-4,4′-bis{2-(methoxyphenyl)ethenyl}, available from Lenape Industries, Inc. (Hillsborough, N.J.) as LENBRITE 127 (CAS #40470-68-6), 1,1′-biphenyl-4,4′-bis[2-(methoxyphenyl)ethenyl], benzene-4,4′-bis(2-(cyano-phenyl)ethenyl), and 1,1′-biphenyl-4,4′-bis[2-(sodium sulfonate phenyl)ethenyl].

With reference to the sole FIGURE, in joining PVC, CPVC, or ABS items together or to each other, the adhesive or primer having the effective amount of the optical brightener is provided 10. Next, the adhesive or primer is processed 12 as appropriate. In the case of the adhesive, the adhesive is applied to both surfaces of the pipes and fittings (or other objects) being joined together. In the case of the primer, the primer is first applied to one or both surfaces of the pipes and fittings (or other objects) being joined, followed by applying the adhesive.

The cured adhesive or primer may be detecting 14 by illuminating the joint with UV (ultraviolet) light, such as from a black light. As is well known, “black light” is a term used commercially for a UV lamp that emits electromagnetic radiation in near-ultraviolet and visible range. Ultraviolet light is typically defined as electro-magnetic radiation with a wavelength in the range of 1 to 380 nm. Typically, near-UV is defined as electromagnetic radiation of 200 to 380 nm. The black light typically emits near-UV and some visible range as well. There are other sources of UV which emit far UV or extreme UV. In most cases, for the optical brighteners employed herein, a range of about 380 to 320 nm, and more specifically, 350 to 340 nm, is suitably used.

### EXAMPLES

### Example 1

A cement known as 719F White was modified by adding certain pigments that glow in the dark to determine proper pipe installation using this glow-in-the-dark characteristic. It is desired that performance of the cements should be the same or better than without the pigment.

The pigments employed were P-1000 pigment (green) and zinc sulfide phosphor (with double activator), both available from Hanovia (Newark, N.J.). Six batches were prepared as follows:
three batches: 719F White, with 1%, 2%, and 4% loading (300 g each); and
three batches: 719F Clear (without TiO₂ and Multiflex MM) with 1%, 2%, and 4% loading (300 g each).

Films 30 mils thick of each cement were cast on a glass plate using a draw down bar. Further, each cement was applied on ¾ inch white and gray pipes with a dauber to observe the glowing effect. The films on the glass plates and pipes were observed in a darkened room. Cements with 1% loading of the pigment did not have a noticeable glow. Cements with 2% pigment had a slightly visible glow, while cements with 4% pigment had a noticeable glow. Cements without TiO₂ had a more noticeable glow than cements with TiO₂ for 2% pigments. Cements without and with TiO₂ exhibited the same results for 4% loading. All observations were the same for the film on the glass plate and applied cements on white and gray pipes.

These results suggest that for a visible glow, at least 2 to 3% of the pigment is required. Based on the inventors' experience, this level of loading is likely to adversely affect the physical and mechanical properties of the adhesives. Also, Hanovia-1000 and zinc sulfide phosphor both glow in the dark, which is not suitable for the intended application.

### Example 2

Lab experiments (Example 1 above) showed that for visible glow, at least 2 to 3 wt % of pigment was required. The shelf stability at 0° F. and 120° F. of the 719F White with 2 wt % Hanovia P-1000 pigment (a pigment available from Hanovia (Newark, N.J.) was comparable with the control (719F White without the pigment). The appearances of the cements changed slightly, depending on the color of the added pigments. These pigments are not approved for indirect food contact applications under 21 CFR—Food and Drugs. Because of the high level of loading (˜2 wt %) and the non-approval under 21 CFR, use of these pigments in solvent cements was deemed undesirable.

Optical brighteners, such as oxazole derivatives, do not glow in the dark, but do glow under “black light” (˜340 to 350 nm; UV-A). These pigments are approved for indirect food contact applications under 21 CFR 175.105, 178.3297, and 177.1520(c).

Batches of 719F White were prepared with 0.002 wt %, 0.005 wt %, and 0.01 wt % LENBRITE 127, LENBRITE OB-1, and LENBRITE OB(D). These modified cements were applied to 2 inch white and gray pipes and were also used to assemble pipe joints The applied cements on pipes and the glue line on the joints were observed to have adequate glow under black light.

Cements with 0.005 wt % optical brighteners had better glow than cements with 1 to 2 wt % pigment under black light. A loading level in the range of 0.002 to 0.005 wt % optical brightener did not change the original appearance of 719F White. Viscosity and shelf stability at 0° F. and 120° F. of cements with 0.005 wt % LENBRITE 127, LENBRITE OB-1, or LENBRITE OB(D) in 719F White were comparable with the control (719F White without the optical brighteners). The lap shear strength of 719F White (with 0.005 wt % LENBRITE 127) was almost the same as the control. The results are tabulated in the Table below.

TABLE
Comparison of 719F White (Control) with Added
Optical Brighteners and Hanovia P-1000 Pigment

| | | | 0.005 wt % | | 0.005 wt % | 0.005 wt % | 2 wt % |
|---|---|---|---|---|---|---|---|
| | | | LENBRITE | | LENBRITE | LENBRITE | Hanovia |
| Ingredients | Control | | 127 | | OB-1 | OB(D) | P-1000 |
| LENBRITE | — | | 0.005 | | — | — | — |
| 127 | | | | | | | |
| LENBRITE | — | | — | | 0.005 | — | — |
| OB-1 | | | | | | | |
| LENBRITE | — | | — | | — | 0.005 | — |
| OB(D) | | | | | | | |
| Hanovia P- | — | | — | | — | — | 2.00 |
| 1000 | | | | | | | |
| Viscosity | 320,000 ± 10.000 | | | | | | |
| Range (cps) | | | | | | | |
| Actual Viscos- | 318,000 | | 318,000 | | 318,000 | 318,000 | 322,000 |
| ity (cps) | | | | | | | |
| Speed/Spindle | 4@1.5 | | 4@1.5 | | 4@1.5 | 4@1.5 | 4@1.5 |
| Shelf Stability | | | | | | | |
| at 0° F.: | | | | | | | |
| After 3 days | OK | | OK | | OK | OK | OK |
| After 4 days | OK | | OK | | OK | OK | OK |
| After 5 days | OK | | OK | | OK | OK | Very heavy |
| After 7 days | Soft gel | | Soft gel | | Soft gel | Soft gel | Soft gel |
| Lap Shear | | | | | | | |
| Strength: | | | | | | | |
| 2 hrs | 396.9 | psi | 371.0 | psi | | | |
| 16 hrs | 724.2 | psi | 734.8 | psi | | | |
| 72 hrs | 1,265.7 | psi | 1,287.3 | psi | | | |

The optical brighteners at the low level of loading had adequate glow under black light. Further, such loading of the optical brighteners did not affect the physical and mechanical properties (appearance, viscosity, shelf stability, and bond strength) of the cement.

What is claimed is:

1. An adhesive or primer for PVC, CPVC, or ABS pipe joints that contains an effective amount of an optical brightener material.

2. The adhesive or primer of claim 1 wherein the effective amount is in the range of 0.001 to 0.9 wt % of the adhesive or primer.

3. The adhesive or primer of claim 2 wherein the effective amount is in the range of 0.005 to 0.5 wt % of the total adhesive or primer.

4. The adhesive or primer of claim 3 wherein the effective amount is about 0.01 wt % of the total adhesive or primer.

5. The adhesive or primer of claim 1 wherein the optical brightener material is a compound selected from the group consisting of oxazole derivatives and biphenyl derivatives.

6. The adhesive or primer of claim 5 wherein the optical brightener material is a bis-benzoxazole derivative.

7. The adhesive or primer of claim 6 wherein the bis-benzoxazole derivative is selected from the group consisting of 2,2′-(1,2-ethenediyldi-4,1-phenylene) bisbenzoazole, 2,2′-(2,5-thiopheny-diyl)-bis[5-(1,1′-dimethyl) benzoxazole, 2,5-bis-(benzoxazole-2-) thiophene, and 2,2-(1,4-naphthalenediyl)bis-benzoxazole.

8. The adhesive or primer of claim 5 wherein the biphenyl derivative is selected from the group consisting of 1,1′-biphenyl-4,4′-bis{2-(methoxyphenyl)-ethenyl}, 1,1′-biphenyl-4,4′-bis[2-(methoxyphenyl)ethenyl], benzene-4,4′-bis(2-(cyano-phenyl)ethenyl), and 1,1′-biphenyl-4,4′-bis[2-(sodium sulfonate phenyl)ethenyl].

9. A method of detecting at least one of an identity of a manufacturer or a leak or a spill of an adhesive or primer, the method comprising:
providing an adhesive or primer for PVC, CPVC, or ABS pipe joints that contains an effective amount of an optical brightener material;
processing the adhesive or primer; and
detecting the adhesive or primer with a source of UV light.

10. The method of claim 9 wherein the effective amount is in the range of 0.001 to 0.9 wt % of the adhesive or primer.

11. The method of claim 10 wherein the effective amount is in the range of 0.005 to 0.5 wt % of the total adhesive or primer.

12. The method of claim 11 wherein the effective amount is about 0.01 wt % of the total adhesive or primer.

13. The method of claim 9 wherein the optical brightener material is selected from the group consisting of oxazole derivatives and biphenyl derivatives.

14. The method of claim 13 wherein the optical brightener material is a bis-benzoxazole derivative.

15. The method of claim 14 wherein the bis-benzoxazole derivative is selected from the group consisting of 2,2′-(1,2-ethenediyldi-4,1-phenylene) bisbenzoazole, 2,2′-(2,5-thiopheny-diyl)-bis[5-(1,1′-dimethyl) benzoxazole, 2,5-bis-(benzoxazole-2-) thiophene, and 2,2-(1,4-naphthalenediyl)bis-benzoxazole.

16. The method of claim 13 wherein the biphenyl derivative is selected from the group consisting of 1,1′-biphenyl-4,4′-bis{2-(methoxyphenyl)-ethenyl}, 1,1′-biphenyl-4,4′-bis[2-(methoxyphenyl)ethenyl], benzene-4,4′-bis(2-(cyanophenyl)ethenyl), and 1,1′-biphenyl-4,4′-bis[2-(sodium sulfonate phenyl)ethenyl].

17. The method of claim 9 wherein the detection is performed using a black light.

18. The method of claim 17 wherein the black light emits radiation at a wavelength of about 200 to 380 nm.
